(19) United States
(12) Patent Application Publication
(10) Pub. No.: US 2023/0137063 A1
(43) Pub. Date: May 4, 2023

(54) DRIVER ASSISTANCE DEVICE

(71) Applicant: ISUZU MOTORS LIMITED, Tokyo (JP)

(72) Inventor: Ryuta TSUDA, Fujisawa-shi, Kanagawa (JP)

(21) Appl. No.: 17/906,484

(22) PCT Filed: Mar. 24, 2021
(86) PCT No.: PCT/JP2021/012227

§ 371 Date: Sep. 16, 2022

(30) Foreign Application Priority Data
Mar. 26, 2020 (JP) 2020-056480

(51) Int. Cl. B60W 50/10; B60W 40/08; B60W 50/16; B60W 10/18; G06V 20/59; G06V 40/16

(52) U.S. Cl. CPC B60W 50/10; B60W 40/08; B60W 50/16; B60W 10/18; G06V 20/597; G06V 40/161; B60W 2050/143

(57) ABSTRACT

A driver assistance device includes an image analysis part that analyzes a captured image obtained by capturing a face of a driver of a vehicle, an abnormality determination processing part that determines whether a state of the driver is an abnormal state on the basis of an analysis result of the captured image and performs an emergency driving stop process of causing the vehicle to perform automatic braking when the driver is determined to be in the abnormal state, and a cancellation detection part that detects a cancellation which the driver makes to cancel an execution of the emergency driving stop process. If the cancellation detection part detects the cancellation within a predetermined time period from when the emergency driving stop process starts, the abnormality determination processing part does not perform the next emergency driving stop process.

### TECHNICAL FIELD

The present invention relates to a driver assistance device that appropriately brakes a vehicle when a driver is in an abnormal state.

### BACKGROUND OF THE INVENTION

Development of an emergency driving stop system that automatically stops a vehicle such as a bus when an abnormality occurs in a driver of the vehicle is promoted. In the emergency driving stop system, when it is determined that the driver is in an abnormal state, the vehicle comes to a stop after a warning, a notification, and automatic braking.

### PRIOR ART

### Patent Document

[Patent Document 1]: Japanese Unexamined Patent Application Publication No. 2019-28766

### BRIEF DESCRIPTION OF THE INVENTION

### Problem to be Solved by the Invention

In the above-described emergency driving stop system, a method of automatically detecting whether or not the driver is in an abnormal state by analyzing a captured image obtained by capturing the driver has been proposed. However, when the driver wears a worn article on his/her face, for example, there is a risk of stopping the vehicle in error by misjudging the driver's state, since the driver's face cannot be appropriately recognized with the method of analyzing the captured image.

The present invention focuses on this point, and its object is to appropriately operate an emergency driving stop system.

### Means for Solving the Problem

An aspect of the present invention provides a driver assistance device including: an image analysis part that analyzes a captured image obtained by capturing a face of a driver of a vehicle; an abnormality determination processing part that determines whether a state of the driver is an abnormal state on the basis of an analysis result of the captured image, and performs an emergency driving stop process of causing the vehicle to perform automatic braking when the driver is determined to be in the abnormal state, and a cancellation detection part that detects a cancellation which the driver makes to stop an execution of the emergency driving stop process, wherein the abnormality determination processing part does not perform a next instance of the emergency driving stop process if the cancellation detection part detects the cancellation within a predetermined time period from when the emergency driving stop process starts.

Further, the abnormality determination processing part may perform the emergency driving stop process when it is determined that the driver's state is one abnormal state among a plurality of abnormal states, and need not perform the next instance of the emergency driving stop process that takes place when it is determined that the driver is in the one abnormal state, if the cancellation detection part detects the cancellation within the predetermined time period.

Further, the cancellation detection part may detect the cancellation when the driver operates a predetermined operation switch.

Further, the abnormality determination processing part: may cause an alarm device to provide a notification to the effect that the vehicle is caused to perform automatic braking when it is determined that the driver is in the abnormal state, and may stop the running emergency driving stop process when the cancellation detection part detects the cancellation within a predetermined time period from the notification.

Further, the abnormality determination processing part may cause an alarm device to provide a notification to the effect that the vehicle is caused to perform automatic braking when it is determined that the driver is in the abnormal state and cause the vehicle to perform automatic braking when the cancellation detection part does not detect the cancellation within the predetermined time period from the notification.

Further, the cancellation detection part may detect the cancellation within the predetermined time period, the abnormality determination processing part need not perform the notification by the alarm device and braking of the vehicle next time.

### Effect of the Invention

According to the present invention, it is possible to appropriately operate an emergency driving stop system.

### BRIEF DESCRIPTION OF THE DRAWINGS

FIG. 1 illustrates a schematic configuration of a vehicle 1 on which a driver assistance device 10 according to an embodiment is mounted.

FIG. 2 schematically illustrates a captured image to be analyzed.

FIG. 3 is a flowchart for illustrating an operation example of the driver assistance device 10.

### DESCRIPTION OF EMBODIMENTS

<Configuration of a Driver Assistance Device>

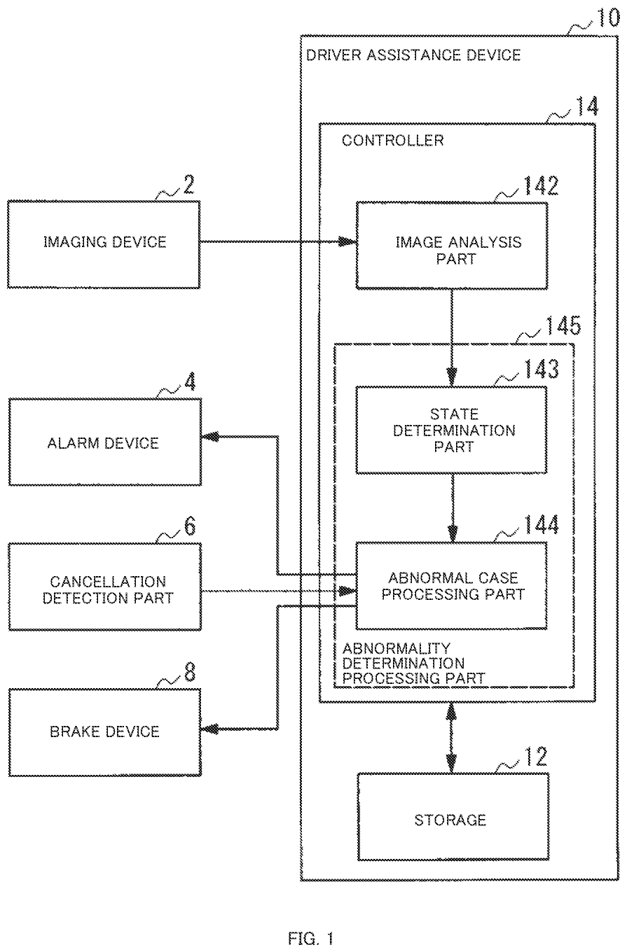

A configuration of a driver assistance device according to an embodiment of the present invention is described with reference to FIG. 1.

FIG. 1 illustrates a schematic configuration of a vehicle 1 on which a driver assistance device 10 according to an embodiment is mounted. The vehicle 1 is a bus, for example. The driver assistance device 10 is capable of executing an emergency driving stop system. When the driver assistance device 10 determines that a driver of the vehicle 1 is in an abnormal state, the driver assistance device 10 issues an alarm and automatically brakes the vehicle 1. The abnormal state of the driver means a case where the driver falls into a situation where he/she cannot safely drive the vehicle 1. For example, the driver assistance device 10 monitors (i) a collapsed posture of the driver, (ii) a closed eye state of the driver, and (iii) whether there is a steering wheel operation by the driver, and automatically determines whether the driver is in the abnormal state.

As shown in FIG. 1, the vehicle 1 includes an imaging device 2, an alarm device 4, a cancellation detection part 6, a brake device 8, and the driver assistance device 10.

The imaging device 2 is a driver monitoring camera that captures an image of the driver while the vehicle 1 is travelling. The imaging device 2 is installed, facing toward the driver, on a meter panel of the vehicle 1 and captures images of the driver's face and posture, for example. The imaging device 2 captures the images at predetermined intervals, and outputs the captured images to the driver assistance device 10.

The alarm device 4 is an alarm part that issues an alarm to the driver. For example, when the driver assistance device 10 determines that the driver is in an abnormal state, the alarm device 4 issues an alarm to alert the driver. The alarm device 4 provides a notification to the effect that the vehicle 1 is being caused to perform automatic braking since the driver is in an abnormal state. The alarm device 4 may include a speaker that makes a sound such as an alarm, a display part that displays a warning screen, and a vibration generation part that generates vibrations.

In addition, the alarm device 4 issues an alarm to inform the people around the vehicle 1 about the abnormality. At this time, the alarm device 4 may turn on or blink various types of lights. This makes it easy for other vehicles and pedestrians to take appropriate measures since they can recognize that the vehicle 1 is in the abnormal state.

The cancellation detection part 6 detects a cancellation which the driver makes to stop the execution of the emergency driving stop process. For example, when the alarm device 4 provides the notification to the effect that the vehicle is being caused to perform automatic braking, the driver can cancel the automatic braking (emergency driving stop process) of the vehicle 1 by operating a predetermined operation switch (hereinafter referred to as a cancel switch) when the driver determines that he/she is not in the abnormal state. The cancellation detection part 6 detects that the cancellation is carried out when the driver operates the cancel switch when the alarm device 4 provided the notification to the effect that automatic braking is executed on the vehicle 1.

The brake device 8 is a device that brakes the moving vehicle 1. For example, the brake device 8 automatically brakes the vehicle 1 if the cancellation detection part 6 does not detect the driver's cancellation within a predetermined time period from when the alarm device 4 starts to provide the notification. The brake device 8 includes a disk brake provided on a wheel of the vehicle 1, for example.

The driver assistance device 10 controls operations of the vehicle 1. Here, the driver assistance device 10 controls operations of the imaging device 2, the alarm device 4, the cancellation detection part 6, and the brake device 8, and executes the emergency driving stop process. When the cancellation detection part 6 detects the driver's cancellation within a predetermined time period from when the emergency driving stop process starts, the driver assistance device 10 does not perform the next emergency driving stop process. By doing this, it is possible to prevent or reduce a repetition of the emergency driving stop process due to an erroneous determination.

As shown in FIG. 1, the driver assistance device 10 includes a storage 12 and a controller 14. The storage 12 includes a read only memory (ROM) and a random access memory (RAM), for example. The storage 12 stores programs to be executed by the controller 14 and various types of data. In addition, the storage 12 stores information such as a threshold value used at the time of determining abnormality.

The controller 14 is a central processing unit (CPU), for example. The controller 14 performs the emergency driving stop process by executing the programs stored in the storage 12. The controller 14 functions as an image analysis part 142, a state determination part 143, and an abnormal case processing part 144, as shown in FIG. 1.

The image analysis part 142 analyzes a captured image obtained by capturing the face of the driver of the vehicle 1. That is, the image analysis part 142 sequentially analyzes captured images captured by the imaging device 2. At this time, the image analysis part 142 analyzes a captured image obtained by the imaging device 2 capturing a predetermined imaging range.

There are cases where a driver puts a worn article on his/her face while the vehicle is traveling. Therefore, the image analysis part 142 may analyze a captured image obtained by capturing a face on which the worn article is worn. For example, the image analysis part 142 analyzes a captured image obtained by capturing a face wearing a black worn article. When the worn article is worn on the face, the image analysis part 142 may not be able to appropriately recognize the face due to the worn article. In particular, when the worn article is black, it becomes even more difficult to recognize the face.

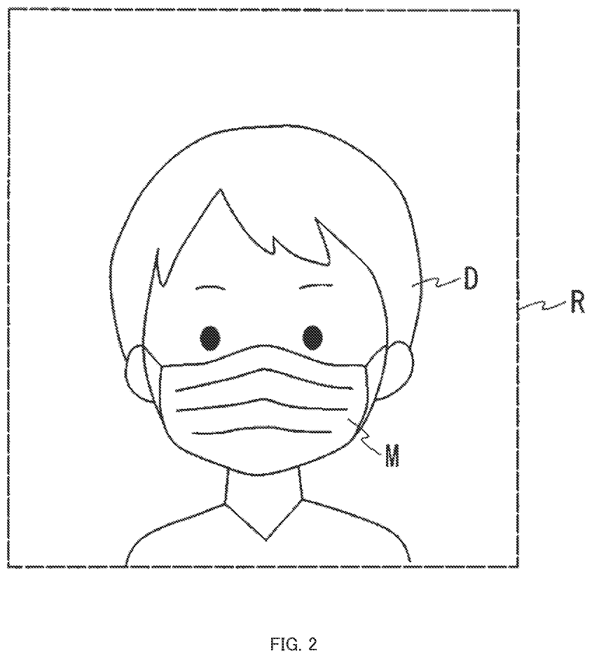

FIG. 2 schematically illustrates a captured image to be analyzed. In the captured image of FIG. 2, the face of a driver D is captured within an imaging range R. Here, a mask M, as the worn article, is worn on the face of the driver D. Since the mask M covers a large area of the driver's face, it becomes difficult for the image analysis part 142 to identify the contour of face, and the image analysis part 142 may not recognize the face appropriately. The mask M has been described as an example of the worn article in the above description, but the present invention is not limited thereto. The worn article may be sunglasses. The mask M may be a black mask. The imaging device 2 captures an image of the driver with an infrared camera, for example. In the case of the black mask, there is a possibility that the face cannot be appropriately detected since the black mask absorbs infrared light.

The state determination part 143 determines the driver's state while the vehicle 1 is traveling. The state determination part 143 determines whether or not the driver's state is any of a plurality of abnormal states, on the basis of an analysis result of the image analysis part 142. For example, when the level and duration of the collapsed posture of the driver are larger than a predetermined threshold, the state determination part 143 determines that the driver is in a first abnormal state. When the driver's closed eye state continues for a predetermined time or longer, the state determination part 143 determines that the driver is in a second abnormal state. It should be noted that the term “collapsed posture” refers to “slumped over,” “dropping one's head,” “bent over backwards,” “arching one's body back,” “head collapsed sideways,” “collapsed sideways,” and “reclined sideways”.

When the state determination part 143 determines that the driver is in an abnormal state (for example, the first abnormal state or the second abnormal state), the abnormal case processing part 144 controls the alarm device 4 and the brake device 8 to perform the emergency driving stop process. Specifically, upon determining that the driver is in the abnormal state, the abnormal case processing part 144 causes the alarm device 4 to issue an alarm. For example, the abnormal case processing part 144 causes the alarm device 4 to provide a notification to the effect that the vehicle 1 is to be caused to perform automatic braking. By doing this, the driver can recognize that the emergency driving stop process will be executed because of the abnormal state.

The abnormal case processing part 144 stops the running emergency driving stop process when the cancellation detection part 6 detects a cancellation (for example, an operation of the cancel switch) within a predetermined time period from the notification. On the other hand, when the cancellation detection part 6 does not detect the driver's cancellation within the predetermined time period, the abnormal case processing part 144 determines that the driver is likely to be in an abnormal state, and causes the vehicle 1 to perform automatic braking by operating the brake device 8.

When the image analysis part 142 can correctly recognize the driver's face, the state determination part 143 can appropriately determine the driver's state. On the other hand, when the image analysis part 142 cannot correctly recognize the face, there is a risk that the state determination part 143 makes an erroneous determination.

In the present embodiment, the state determination part 143 and the abnormal case processing part 144 function as an abnormality determination processing part 145 that performs the emergency driving stop process of causing the vehicle 1 to perform automatic braking on the basis of an automatic detection of the abnormal state of the driver. The abnormality determination processing part 145 prevents a repetition of the emergency driving stop process due to an erroneous determination, which is described above.

Specifically, if the cancellation detection part 6 detects the cancellation within a predetermined time period from when the emergency driving stop process is started, the abnormality determination processing part 145 does not perform the next emergency driving stop process. Even if the driver's state becomes abnormal after that, the abnormality determination processing part 145 does not perform (i) a notification by the alarm device 4 and (ii) braking of the vehicle 1 after notification. For example, when the driver has put on a worn article such as a mask, the emergency driving stop process will not be performed since there is a possibility that an erroneous determination is repeatedly made.

If the cancellation detection part 6 detects the cancellation within the predetermined time period, the abnormality determination processing part 145 does not perform the emergency driving stop process that takes place the next time it is determined that the driver is in one abnormal state (for example, the first abnormal state). As a result, it is possible to prevent a repetition of the emergency driving stop process due to the first abnormal state. On the other hand, the abnormality determination processing part 145 performs the emergency driving stop process when the abnormality determination processing part 145 determines that the driver is in the second abnormal state, even when the cancellation detection part 6 detects the cancellation. By doing this, it is possible to prevent the emergency driving stop process from not being performed when the driver is in another abnormal state (the second abnormal state) for some reason.

In the above description, the abnormality determination processing part 145 performs the emergency driving stop process when the abnormality determination processing part 145 automatically detects that the driver is in the abnormal state by analyzing the captured images obtained by capturing the driver, but it is not limited to this. For example, when the driver does not perform the steering wheel operation continuously for a predetermined time or longer, the abnormality determination processing part 145 may perform the emergency driving stop process regardless of the analysis of the captured images. Further, the abnormality determination processing part 145 may perform the emergency driving stop process when a passenger of the vehicle 1 presses a predetermined switch (e.g., an emergency stop switch). The abnormality determination processing part 145 executes the emergency driving stop process due to the pressing of the switch by the passenger, even when the cancellation detection part 6 detects the cancellation.

<Operation Example of the Driver Assistance Device>

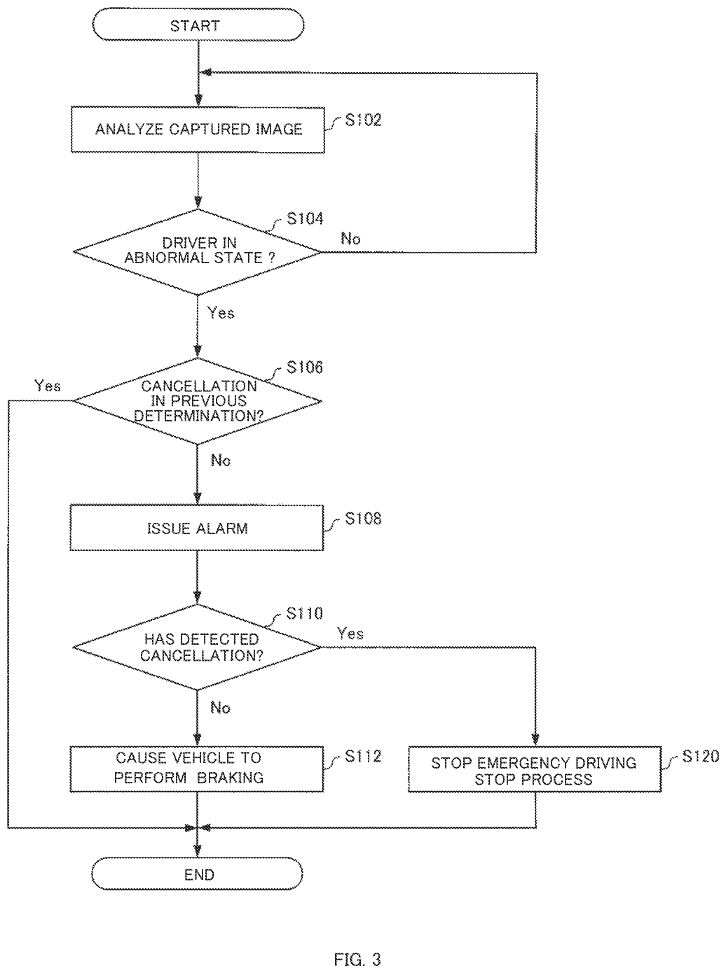

An operation example of the driver assistance device 10 will be described with reference to FIG. 3. FIG. 3 is a flowchart for illustrating the operation example of the driver assistance device 10. Processes shown in FIG. 3 start when the imaging device 2 captures an image of the driver while the vehicle 1 is traveling. The captured images captured by the imaging device 2 are output to the image analysis part 142.

The image analysis part 142 analyzes the captured images captured by the imaging device 2 (step S102). For example, the image analysis part 142 recognizes a face of the driver in the captured images. Further, the image analysis part 142 obtains the amount of change in the driver's posture, the driver's closed eye state, and the like.

Next, the state determination part 143 determines whether the driver is in an abnormal state on the basis of an analysis result of the image analysis part 142 (step S104). For example, the state determination part 143 determines whether the driver is (i) in a first abnormal state in which the collapsed posture of the driver is severe or (ii) in a second abnormal state in which the driver's closed eye state is continuing.

When it is determined in step S104 that the driver is in the abnormal state (here, it is assumed to be the first abnormal state) (Yes), the abnormal case processing part 144 determines whether there is any cancellation performed by the driver in the previous determination (step S106).

When it is determined in step S106 that no cancellation was performed in the previous determination (No), the abnormal case processing part 144 causes the alarm device 4 to issue an alarm (step S108). Specifically, the alarm device 4 provides a notification to the effect that the vehicle 1 is caused to perform automatic braking.

Next, the abnormal case processing part 144 determines whether or not the cancellation detection part 6 has detected the cancellation performed by the driver within a predetermined time period from the notification (step S110). The cancellation detection part 6 detects the cancellation performance when the driver operates the cancel switch, for example.

When the cancellation performance is not detected in step S110 (No), the abnormal case processing part 144 operates the brake device 8 to cause the vehicle 1 to perform automatic braking. This makes it possible to safely stop the vehicle 1 in which the driver is in the abnormal state.

On the other hand, when the cancellation performance is detected in step S110 (Yes), the abnormal case processing part 144 stops the running emergency driving stop process (such as the notification by the alarm device 4) (step S120). The abnormal case processing part 144 causes the storage 12 to store cancellation information about cancelling the execution of the emergency driving stop process due to the abnormal state (i.e., the first abnormal state) which is determined in step S104. The cancellation information is used in the next determination.

When it is determined in step S106 that the cancellation was performed in the previous determination (Yes), the abnormal case processing part 144 does not perform the emergency driving stop process of steps S108 to S112. That is, when the cancellation information is stored in the storage 12 in the previous determination, the abnormal case processing part 144 does not perform the notification by the alarm device 4 in step S108 and braking of the vehicle in step S112. The driver assistance device 10 continuously performs the series of processes described above while the vehicle 1 is traveling.

Although not shown in the flowchart of FIG. 3, if the abnormal state (first abnormal state) determined in step S104 and the abnormal state indicated by the cancellation information stored in the storage 12 are the same, the abnormal case processing part 144 does not perform the emergency driving stop process. On the other hand, if the abnormal state determined in step S104 is different from the abnormal state indicated by the cancellation information stored in the storage 12, the abnormal case processing part 144 may perform the emergency driving stop process.

### EFFECTS OF THE PRESENT EMBODIMENT

The driver assistance device 10 according to the embodiment described above determines whether or not the driver is in the abnormal state on the basis of the analysis result of the captured images, and performs the emergency driving stop process of causing the vehicle 1 to perform automatic braking when the driver is in the abnormal state. On the other hand, when the cancellation detection part 6 detects the cancellation performance (such as operation of the cancel switch) within a predetermined time period from when the emergency driving stop process starts, the driver assistance device 10 does not perform the next emergency driving stop process. For example, when the driver put the worn article such as a mask, there is a risk that an erroneous determination that the driver is in the abnormal state is repeatedly made and the emergency driving stop process is performed every time such an erroneous determination is made. On the other hand, by not performing the next emergency driving stop process when the driver assistance device 10 of the present embodiment detects the cancellation, it is possible to prevent the emergency driving stop process from being operated due to an erroneous determination of the abnormality state of the driver. In this manner, since there is no need for the driver to perform the cancellation execution again, it is possible to prevent the driver from making unnecessary actions while driving.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

### DESCRIPTION OF THE REFERENCE NUMERALS

1 Vehicle
2 Imaging device
6 Cancellation detection part
10 Driver assistance device
142 Image analysis part
145 Abnormality determination processing part

1. A driver assistance device comprising:
an image analysis part that analyzes a captured image obtained by capturing a face of a driver of a vehicle;
an abnormality determination processing part that determines whether a state of the driver is an abnormal state on the basis of an analysis result of the captured image, and performs an emergency driving stop process of causing the vehicle to perform automatic braking when the driver is determined to be in the abnormal state, and
a cancellation detection part that detects a cancellation which the driver makes to stop an execution of the emergency driving stop process, wherein
the abnormality determination processing part does not perform a next instance of the emergency driving stop process if the cancellation detection part detects the cancellation within a predetermined time period from when the emergency driving stop process starts.

2. The driver assistance device according to claim 1, wherein
the abnormality determination processing part performs the emergency driving stop process when it is determined that the driver's state is one abnormal state among a plurality of abnormal states, and does not perform the next instance of the emergency driving stop process that takes place when it is determined that the driver is in the one abnormal state, if the cancellation detection part detects the cancellation within the predetermined time period.

3. The driver assistance device according to claim 1, wherein the cancellation detection part detects the cancellation when the driver operates a predetermined operation switch.

4. The driver assistance device according to claim 1, wherein
the abnormality determination processing part: causes an alarm device to provide a notification to the effect that the vehicle is caused to perform automatic braking when it is determined that the driver is in the abnormal state, and stops the running emergency driving stop process when the cancellation detection part detects the cancellation within a predetermined time period from the notification.

5. The driver assistance device according to claim 1, wherein the abnormality determination processing part causes an alarm device to provide a notification to the effect that the vehicle is caused to perform automatic braking when it is determined that the driver is in the abnormal state and causes the vehicle to perform automatic braking when the cancellation detection part does not detect the cancellation within the predetermined time period from the notification.

6. The driver assistance device according to claim 5, wherein, when the cancellation detection part detects the cancellation within the predetermined time period, the abnormality determination processing part does not perform the notification by the alarm device and braking of the vehicle next time.

7. The driver assistance device according to claim 2, wherein the abnormality determination processing part performs the next instance of the emergency driving stop process that takes place when it is determined that the driver is in the abnormal states other than the one abnormal state even if the cancellation detection part detects the cancellation within the predetermined period.
